(19) United States
(12) Patent Application Publication
(10) Pub. No.: US 2014/0331134 A1
(43) Pub. Date: Nov. 6, 2014

(54) SYSTEM, A PROCESSOR APPARATUS AND A METHOD FOR MODIFICATION OF CONTROL SIGNALS

(71) Applicant: Creative Technology Ltd, Singapore (SG)

(72) Inventors: Teck Chee Lee, Singapore (SG); Peng Kheong Lam, Singapore (SG); Anders Norrman, Singapore (SG); Wee Wei Leow, Singapore (SG)

(73) Assignee: CREATIVE TECHNOLOGY LTD, Singapore (SG)

(21) Appl. No.: 14/370,641

(22) PCT Filed: Jan. 2, 2013
(86) PCT No.: PCT/SG2013/000001

§ 371 Date: Jul. 3, 2014

(30) Foreign Application Priority Data
Jan. 10, 2012 (SG) 201200195-4

(51) Int. Cl. G06F 3/0484

(52) U.S. Cl. CPC G06F 3/0484
USPC 715/716

(57) ABSTRACT

A system, a processor apparatus and a method for modification of control signals. The apparatus can include a processor and a control portion. The processor can be coupled to the control portion. The processor can be configured to receive and process input signals in a manner so as to produce output signals. The processor can be associated with response characteristics. The control portion can be configured to produce control signals. The control signals can be communicated to the processor. The control portion can be configured to receive data signals. The control signals can be modified based on the data signals. Response characteristics associated with the processor can be varied based on the modifiable control signals and the processor can be further configured to process received input signals based on the variable response characteristics so as to produce the output signals.

### FIELD OF INVENTION

The present disclosure generally relates a system, a processor apparatus and a method for modification of control signals. More particularly, various embodiments of the disclosure relate to a system, a processor apparatus and a method for modifying control signals for varying response characteristics associable with the system and/or the processor apparatus.

### BACKGROUND

In general, electronic systems can be configured to receive input signals and process the input signals to produce output signals. An example would be an audio system.

An audio system can include a source portion such as a CD source or a tuner source. The audio system can further include an equalization (EQ) system and speaker outputs. In this regard, the aforementioned input signals can correspond to audio signals. Audio signals can include low-range frequency signals (e.g., bass frequencies which can be between 20 Hz and 200 Hz), mid-range frequency signals (e.g., frequencies which can be between 300 Hz and 5 kHz) and high-range frequency signals (e.g., treble frequencies which can be between 5.1 kHz and 20 kHz).

Audio signals can be communicated from, for example, the CD source and processed by the EQ system. The EQ system can be configured to process the audio signals so as to adjust frequency response by, for example, one of boosting and attenuating one or both of the bass frequencies and treble frequencies. The processed audio signals can be output via the speaker outputs.

Usually, the EQ system processes the audio signals in a predetermined manner. Specifically, frequency response curves are preprogrammed into the EQ system. The frequency response curves determine how frequency response of the audio signals can be adjusted. For example, one of the frequency response curves can be selected and based on the selected frequency curve the EQ system processes the audio signals accordingly.

However, it may be desired to control the manner in which the EQ system processes the audio signals. Specifically, it may be desirable to customize how the EQ system adjusts frequency response of audio signals as opposed to the aforementioned predetermined manner which involves simply selecting a frequency response curve out of the frequency response curves preprogrammed into the EQ system.

Conventional techniques for controlling/customizing how the EQ system adjusts frequency response include providing dedicated controls, which can be in the form of individual control knobs and/or buttons, to control one or more specific frequencies in each of the aforementioned low-range frequency signals, mid-range frequency signals and high-range frequency signals. For example, a control knob and/or button can be used to adjust a specific frequency.

Appreciably, a user desiring to control or customize how the EQ system adjusts frequency response would need to use individual control knobs and/or buttons to adjust the corresponding frequencies. Thus the user is burdened with having to cope with multiple control knobs and/or buttons.

Thus conventional techniques do not facilitate customization or control in a suitably efficient manner.

Moreover, conventional techniques do not provide a safeguard in case the EQ system has been inadvertently controlled or customized to adjust frequency response in a manner which might potentially detract listening experience.

It is therefore desirable to provide a solution to address at least one of the foregoing problems of conventional techniques.

### SUMMARY OF THE INVENTION

In accordance with an aspect of the disclosure, an apparatus is provided. The apparatus can include a processor and a control portion. The processor can be coupled to the control portion.

The processor can be configured to receive and process input signals in a manner so as to produce output signals. The processor can be associated with response characteristics.

The control portion can be configured to produce control signals. The control signals can be communicated to the processor. The control portion can be configured to receive data signals. The control signals can be modified based on the data signals.

Response characteristics associated with the processor can be varied based on the modifiable control signals and the processor can be further configured to process received input signals based on the variable response characteristics so as to produce the output signals.

In one embodiment, the control portion can include an input module. The input module can be configured to receive the data signals which can be associated with gesture based inputs. The gesture based inputs can be applied using the input module for graphically modifying the control signals.

In particular, the input module can, for example, be capable of receiving gesture based inputs and translating the gesture based inputs into data signals. Additionally, the input module can, for example, be touch sensitive and gesture based inputs can be applied using the input module based on contact.

The gesture based inputs can, in one embodiment, correspond to a graphic representation and the graphic representation can be drawn on the input module using at least one of a contact apparatus and a finger.

Additionally, the graphical representation can be associated with a plurality of data points and the input signals can include a plurality of signal components. The plurality of data points can correspond to the plurality of signal components. Moreover, at least one of the aforementioned plurality of data points can, for example, be graphically modified in a manner so as to correspondingly modify signal components of a corresponding input signal. The aforementioned at least one graphically modifiable data point can, for example, correspond to a fundamental modifiable point.

The fundamental modifiable point can, for example, be modified by an amount proportional to the graphical modification of the corresponding at least one of the plurality of data points. The amount of modification of the fundamental modifiable point can correspond to fundamental extent of variation.

In one embodiment, points adjacent to the fundamental modifiable point can be modified. The points adjacent to the fundamental modifiable point can be auxiliary modifiable points. The auxiliary modifiable points can be associated with a plurality of secondary extent of variations. Each of the plurality of secondary extent of variations can, for example, be less compared to the fundamental extent of variation.

The fundamental modifiable point and points adjacent to the fundamental modifiable points can collectively correspond to a response curve associable with a bandwidth relative to the fundamental modifiable point. Additionally, the bandwidth can, for example, be associated with Q factor. The bandwidth can be varied. Based on the variable bandwidth, Q factor can be correspondingly varied.

Earlier mentioned, the control portion can include an input module

Further earlier mentioned, in one embodiment, the input module can be configured to receive the data signals and the data signals can be associated with gesture based inputs. The gesture based inputs can be applied using the input module for graphically modifying the control signals.

In another embodiment, the input module can be configured to apply gesture based inputs for drawing a graphic representation so as to graphically modify the control signals communicable to the processor.

Furthermore, the apparatus can be configured to communicate with an input device. The input device can be associated with response characteristics. The input device can be configured to produce training signals corresponding to the aforementioned data signals. The training signals can be indicative of the response characteristics of the input device.

### BRIEF DESCRIPTION OF THE DRAWINGS

Embodiments of the disclosure are described hereinafter with reference to the following drawings, in which:

FIG. 1a shows a system which can include an input portion, a processor apparatus and an output portion, in accordance with an embodiment of the disclosure;

FIG. 1b shows that the system of FIG. 1a can further include an input device which can be coupled to the processor apparatus and, optionally, the input portion, in accordance with an embodiment of the disclosure;

FIG. 2 shows the system of FIG. 1a/FIG. 1b in further detail where the processor apparatus can include a processing portion and a control portion which can include an input module, in accordance with an embodiment of the disclosure;

FIG. 3a shows a first exemplary application of the system of FIG. 2 where gesture based inputs corresponding to a graphical representation in the form of a response graph can be applied using the input module, in accordance with an embodiment of the disclosure;

FIG. 3b shows that the response graph of FIG. 3a can be associated with one or more axes, in accordance with an embodiment of the disclosure;

FIG. 3c shows a first exemplary scenario where the response graph of FIG. 3a can initially correspond to a flat response graph, in accordance with an embodiment of the disclosure;

FIG. 3d shows that in the first exemplary scenario of FIG. 3a, the flat response graph can be modified to obtain a response curve by contacting the input module which can correspond to a touch sensitive screen, in accordance with an embodiment of the disclosure;

FIG. 3e shows a second exemplary scenario where the response curve of FIG. 3d can optionally be varied or adjusted to vary or adjust Q factor associable with the response curve, in accordance with an embodiment of the disclosure;

FIG. 4 shows the response curve of FIG. 3d in further detail, in accordance with an embodiment of the disclosure; and

FIG. 5 shows a second exemplary application of the system of FIG. 2, in accordance with an embodiment of the disclosure;

FIG. 6a and FIG. 6b show that the processing apparatus of FIG. 1a/FIG. 1b can further include an adjustment module, in accordance with an embodiment of the disclosure; and

FIG. 7 shows a method in association with the system of FIG. 1a/FIG. 1b, in accordance with an embodiment of the disclosure.

### DETAILED DESCRIPTION

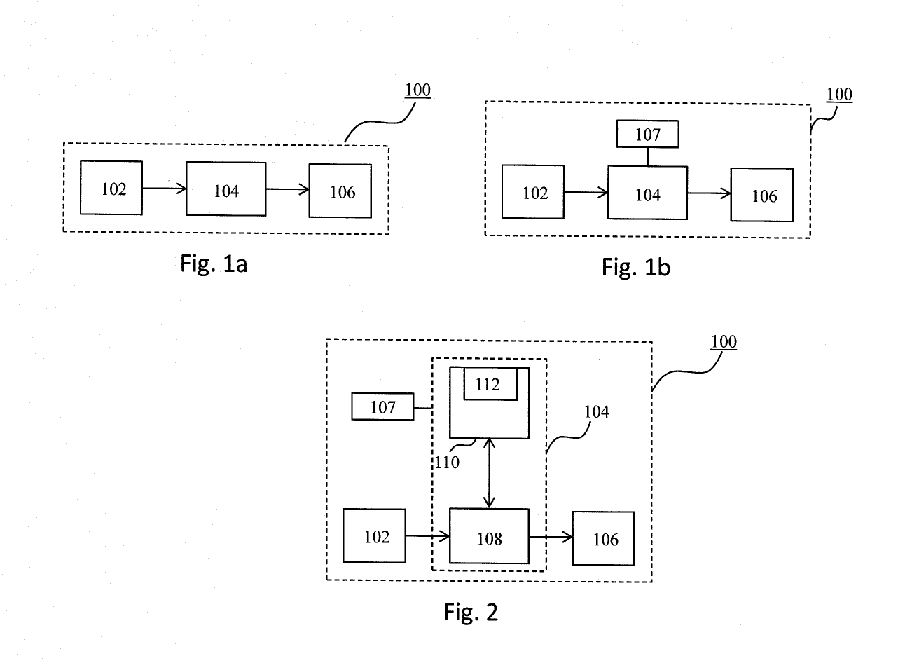

Representative embodiments of the disclosure, for addressing one or more of the foregoing problems associated with conventional techniques, are described hereinafter with reference to FIG. 1 to FIG. 7.

A system 100, in accordance with an embodiment of the disclosure, is shown in FIG. 1a. The system 100 can include an input portion 102, a processor apparatus 104 (which can simply be referable as “apparatus”) and an output portion 106. The input portion 102 can be coupled to the processor apparatus 104. The processor apparatus 104 can be coupled to the output portion 106.

The input portion 102 can be configured to communicate input signals to the processor apparatus 104. The processor apparatus 104 can be configured to receive and process the received input signals in a manner so as to produce output signals. The output signals can be further communicated from the processor apparatus 104 to the output portion 106 for output.

Referring to FIG. 1b, the system 100, in accordance with another embodiment of the disclosure, can optionally further include an input device 107. The input device 107 can be coupled to the processor apparatus 104. The input device 107 can optionally be coupled to the input portion 102.

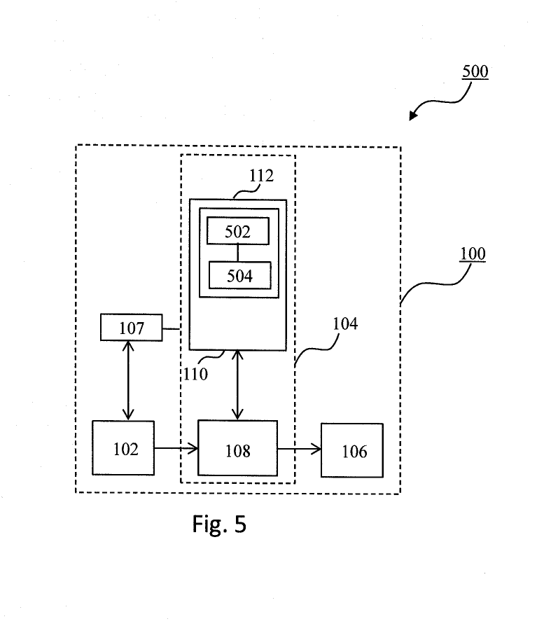

Additionally, the input device 107 can be configured to generate and communicate training signals to the processor apparatus 104. The processor apparatus 104 can be configured to process the training signals as will be discussed later in further detail with reference to FIG. 2 and FIG. 5.

Moreover, the input device 107 can be coupled to the input portion 102 in a manner such that the input device 107 and the input portion 102 can signal communicate with each other. For example, the input portion 102 can be configured to communicate input signals to the input device 107. The input device 107 can, for example, be configured to receive the input signals for processing to produce the training signals.

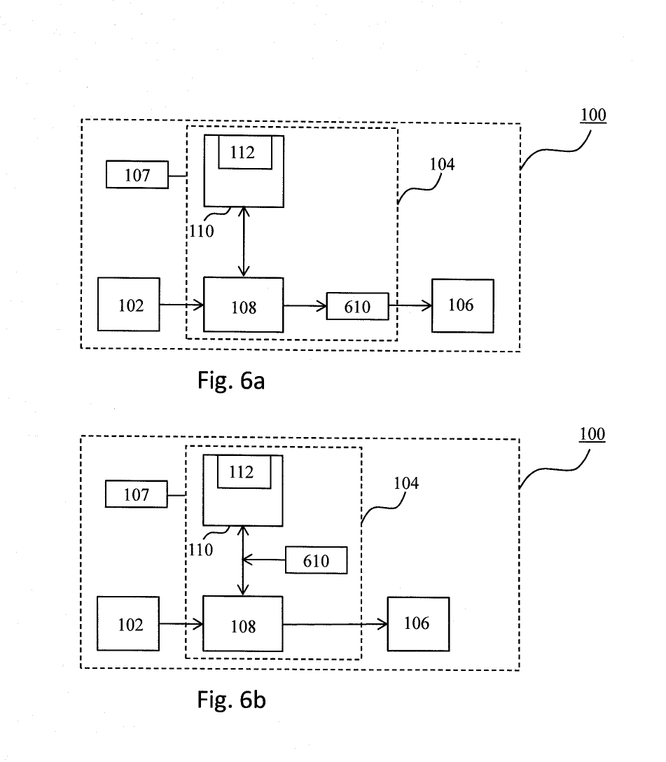

FIG. 2 shows the system 100 in further detail, in accordance with an embodiment of the disclosure. Particularly, as shown, the processor apparatus 104 can, in one embodiment, include a processing portion 108 and a control portion 110. Additionally, the control portion 110 can include an input module 112. The processor apparatus 104 can, in another embodiment as will be discussed in further detail with reference to FIG. 6, further include an adjustment module.

The processing portion 108 can be coupled to the control portion 110. Additionally, the processing portion 108 can be coupled to the input portion 102. The processing portion 108 can be further coupled to the output portion 106. Moreover, the input portion 102 can optionally be coupled to the control portion 110.

The processing portion 108 can be associated with response characteristics. Additionally, the processing portion 108 can be configured to receive and process the input signals communicated from the input portion 102 in a manner so as to produce output signals.

Specifically, the processing portion 108 can be configured to process the received input signals based on the response characteristics so as to produce the output signals. More specifically, the processing portion 108 can be configured to modify the received input signals based on the response characteristics so as to produce output signals. In this manner, the output signals can be based on received input signals modified by response characteristics associated with the processing portion 108. Additionally, response characteristics associated with the processing portion 108 can be varied as will be discussed later in further detail.

The control portion 110 can be configured to produce control signals which can be modified. The control signals can be communicated from the control portion 110 to the processing portion 108.

Specifically, the input module 112 can be configured in a manner so as to modify the control signals. More specifically, the input module 112 can be configured to receive/accept data signals and the control signals can be modified based on the data signals.

In one embodiment, the data signals can be associated with gesture based inputs. The gesture based inputs can correspond to a graphical representation. In this regard, the input module 112 can, for example, be configured to translate the gesture based inputs into data signals. Moreover, the graphical representation can be associated with one or more data points. Earlier mentioned, the control signals can be graphically modified based on the data signals. For example, a user can, using the input module 112, apply gesture based inputs corresponding to the aforementioned graphical representation for graphically modifying the control signals. In the foregoing manner, control signals, which can be communicated to the processing portion 108, can be graphically modified.

In another embodiment, the data signals can correspond to the aforementioned training signals. Earlier mentioned, the training signals can be communicated from the input device 107. The input device 107 can be associated with response characteristics. In this regard, the training signals can be indicative of response characteristics of the input device 107. The control signals can be modified based on the training signals which, as mentioned earlier, can correspond to the data signals.

Since control signals can be modified based on the data signals which correspond to the training signals and the training signals can be indicative of response characteristics of the input device 107, it is appreciable that control signals can be modified in accordance with response characteristics of the input device 107.

Thus the control signals can be modified in an adaptive manner. More specifically, the control signals can be modified based on adaptation of the response characteristics of the input device 107 (i.e., adapting to the response characteristics of the input device 107). Therefore, control signals, which can be communicated to the processing portion 108, can be adaptively modified. In the foregoing manner, the control portion 110 can be configured to learn the response characteristics of the input device 107 and modify the control signals accordingly (i.e., adaptively modify the control signals).

In yet another embodiment, the control signals can be graphically modified and adaptively modified.

Earlier mentioned, response characteristics associated with the processing portion 108 can be varied. Specifically, response characteristics associated with the processing portion 108 can be varied based on one or both of graphically modifiable control signals and adaptively modifiable control signals as will be discussed in further detail hereinafter.

The control signals, as mentioned earlier, can be one or both graphically modified and adaptively modified. The graphically modifiable control signals and/or the adaptively modifiable control signals can be communicated from the control portion 110. Additionally, the graphically modifiable control signals and/or the adaptively modifiable control signals can be communicated to the processing portion 108.

Based on the graphically modifiable control signals and/or the adaptively modifiable control signals, response characteristics of the processing portion 108 can be varied accordingly. In this regard response characteristics of the processing portion 108 can be variable. Thus the processing portion 108 can be configured to process received input signals based on the variable response characteristics so as to produce the output signals.

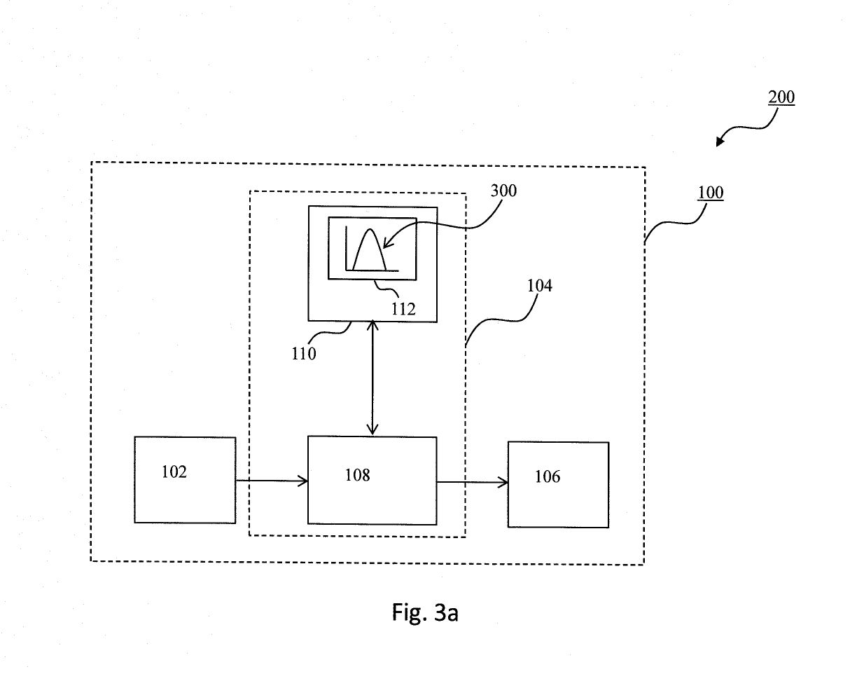

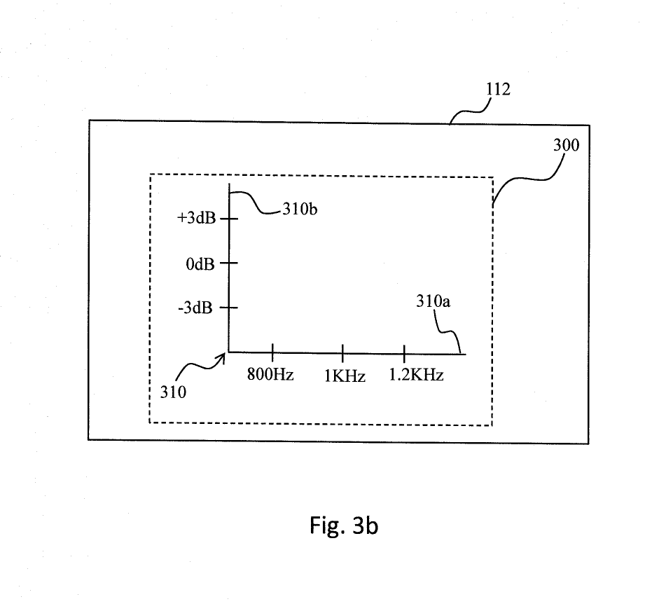

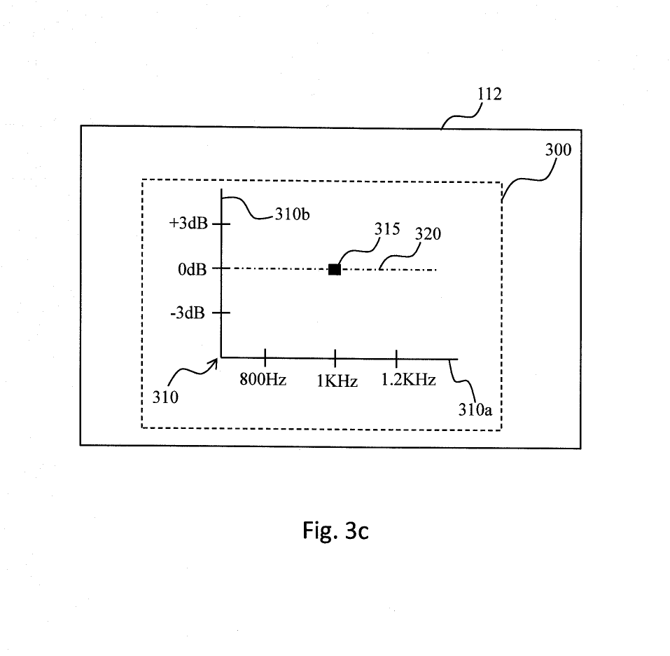

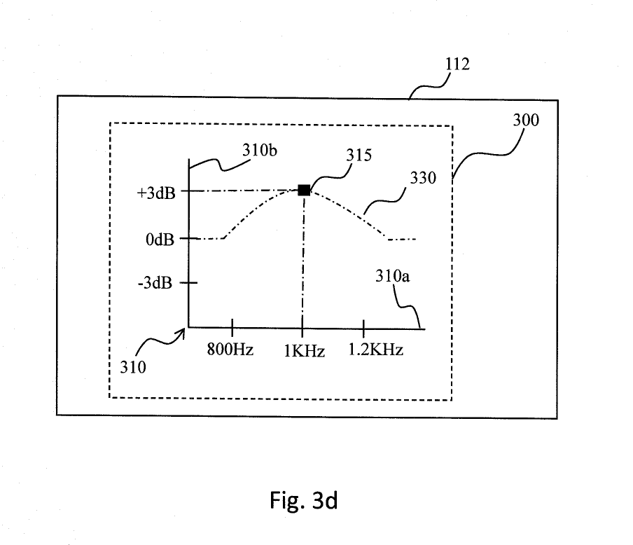

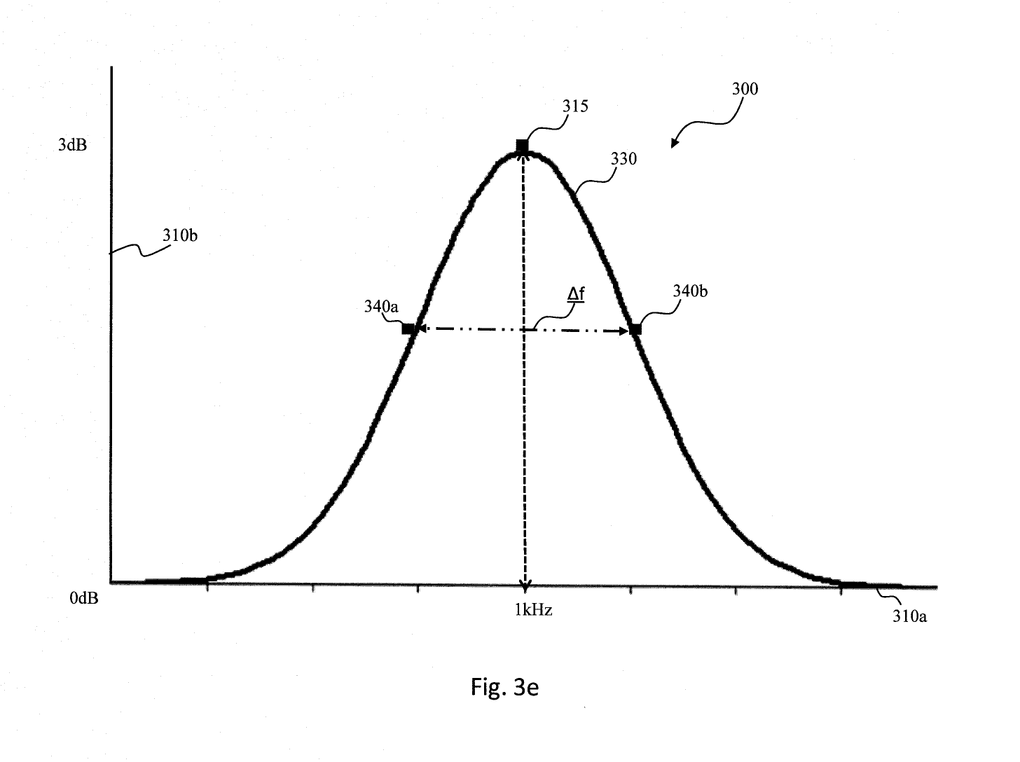

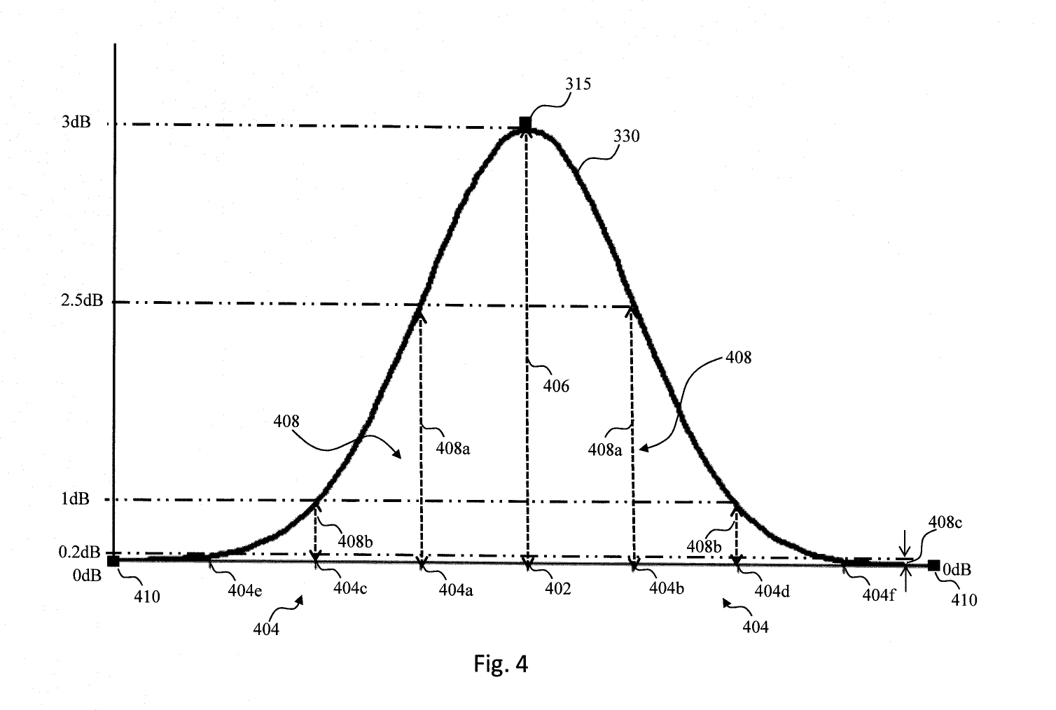

The system 100 will be discussed in further detail with reference to FIG. 3a to FIG. 5 hereinafter. Specifically, the system 100 will be discussed in further detail in the context of a first exemplary application with reference to FIG. 3a to FIG. 4. Additionally, the system 100 will also be discussed in further detail in the context of a second exemplary application with reference to FIG. 5.

FIG. 3a shows a first exemplary application 200 of the system 100. The first exemplary application 200 can be in association with the aforementioned graphical modification of the control signals. Earlier mentioned, a user can, for example, apply gesture based inputs corresponding to a graphical representation for graphically modifying control signals. Further earlier mentioned, the graphical representation can be associated with one or more data points.

The gesture based inputs can be applied using the input module 112. In the first exemplary application 200, the graphical representation can be in the form of a response graph 300. In this regard, the response graph 300 can be associated with one or more data points. The response graph 300 will be discussed in further detail with reference to FIG. 3b to FIG. 3d

In the first exemplary application 200, the system 100 can correspond to an electronic device. The electronic device can have a display screen. The display screen can, for example, be a touch sensitive screen. In this regard, the input module 112 can, for example, correspond to a touch sensitive screen. Additionally, the system 100 can be configured to modify audio signals. Specifically, the audio signals can be modified in a graphical based manner.

In this regard, the input portion 102 can be configured to generate audio signals and the audio signals can be communicated from the input portion 102 to the processor apparatus 104. Thus, the aforementioned input signals can correspond to audio signals.

Each of the audio signals can be associated with signal components. A data point associable with the graphical representation can correspond to the signal components of an audio signal. Thus a plurality of data points can correspond to signal components of a corresponding plurality of audio signals.

Signal components can include a frequency component and a magnitude component. The frequency component can be indicative of frequency of an audio signal and the magnitude component can be indicative of signal strength of an audio signal. Signal strength can, for example, correspond to loudness of an audio signal.

Audio signals communicated from the input portion 102 can be received by the processor apparatus 104 for processing in a manner so as to produce output signals. Specifically, audio signals communicated from the input portion 102 can be received by the processing portion 108.

The processing portion 108 can be configured to vary/modify signal components of the audio signals based on graphically modifiable control signals communicated from the control module 110. More specifically, the processing portion 108 can be configured to vary/modify, for example, one or both of the frequency component and the magnitude component based on graphically modifiable control signals. Earlier mentioned, gesture based inputs corresponding to a graphical representation can be applied for graphically modifying control signals. The graphical representation can be in the form of the aforementioned response graph 300 which will be discussed in further detail hereinafter.

Referring to FIG. 3b, the response graph 300 can be associated with one or more axes 310. For example, the response graph 300 can be associated with a frequency axis 310a and a gain axis 310b. In this regard, the aforementioned one or more axes 310 can correspond to a frequency axis 310a and a gain axis 310b.

The frequency axis 310a can be indicative of frequency components of the input signals and the gain axis 310b can be indicative of gain which can be applied to the magnitude components of the input signals. As shown, on the frequency axis 310a, the frequency components can, for example, be quantified in Hertz (Hz) and/or Kilo Hertz (kHz). Furthermore, on the gain axis 310b, gain which can be applied to the magnitude components of the input signals can, for example, be quantified in decibels (dB).

Additionally, earlier mentioned, the input module 112 can, for example, be a touch sensitive screen. Thus the response graph 300 can be graphically displayed using the input module 112. In various scenarios as will be discussed later in further detail with reference to FIG. 3c to FIG. 3e, a user can modify the response graph 300 by contacting the touch sensitive screen.

Particularly, in a first exemplary scenario, as will be discussed later in further detail with reference to FIG. 3c and FIG. 3d, a user can make modifications in relation to frequency response. In this regard, response characteristics of the processing portion 108 can correspond to frequency response and the control portion 110 can be configured to modify frequency response.

Specifically, the control portion 110 can be configured to modify frequency response of the processing portion 108 in a graphical based manner corresponding to the response graph 300. Modification of frequency response of the processing portion 108 can, for example, be associated with varying the magnitude component corresponding to a frequency component. Particularly, modification of frequency response of the processing portion 108 can be associated with predetermining gain applied to the magnitude component corresponding to a frequency component, as will be discussed with reference to FIG. 3b to FIG. 3d later.

In a second exemplary scenario, as will be discussed later in further detail with reference to FIG. 3e, a user can make modifications in relation to Q factor in addition to frequency response.

In the aforementioned exemplary scenarios, a user can, using a finger or a contact apparatus such as a stylus, contact an appropriate portion of the input module 112 to vary one or both of frequency response and Q factor. In this regard, the earlier mentioned gesture based inputs can be applied by a user using, for example, one or both of a finger and a contact apparatus to contact an appropriate portion of the input module 112. Thus, the graphic representation can, for example, be drawn on the input module 112 using at least one of a contact apparatus and a finger.

Appreciably, in this manner, the user can be afforded an avenue for varying one or both of frequency response and Q factor in an intuitive manner. For example, a user can simply draw a graphic representation for varying one or both of frequency response and Q factor as opposed to having to, for example, control individual control knobs and/or buttons as discussed in association with the aforementioned conventional techniques.

Referring to FIG. 3c, in the first exemplary scenario, the response graph 300 can include a data point 315. Additionally, the response graph 300 can initially correspond to a flat response graph 320. The flat response graph 320 can, for example, signify either constant gain or unity gain equally at all frequencies.

In the case of constant gain, gain applied to the magnitude components of the input signals is the same. The gain applied can either be a positive gain or a negative gain in terms of decibels. In this regard, response characteristics of the processing portion 108 can correspond to uniform gain based response where a constant gain is applied to audio signals received by the processing portion 108. In one example, where a positive gain is applied, the output signals produced by the processing portion 108 can correspond to amplified input signals. In another example, where a negative gain is applied, the output signals produced by the processing portion 108 can correspond to attenuated input signals.

In the case of unity gain, no gain is applied to the magnitude components. More specifically, for unity gain, it is understood that a gain factor of numerical value “1” can be applied to the magnitude components. In this regard, response characteristics of the processing portion 108 can correspond to unity gain based response wherein a gain of numerical value “1” is applied to audio signals received by the processing portion 108. Thus the output signals produced by the processing portion 108 can substantially be the same as the input signals.

In one example, as illustrated in FIG. 3c, the flat response graph 320 indicates that a 0 dB gain is applied to the audio signals. More specifically, a gain of 0 dB is applied to magnitude components of the input signals. A 0 dB gain can correspond to the aforementioned unity gain.

In the first exemplary scenario, a user, desiring to modify a 1 kHz frequency component, may contact the portion of the input module 112 where 1 kHz is indicated on the frequency axis 310a using, for example, a stylus. Following that, the user may move the stylus in one or more directions with reference to the gain axis 310b. For example, user may move the stylus up or down with reference to the gain axis 310b. By moving the stylus up or down, it is appreciable that gain applied to the magnitude component corresponding to the 1 kHz frequency component can be varied as desired.

In this case, the 1 kHz frequency component and the corresponding magnitude component can correspond to a data point 315 on the flat response graph 320. Appreciably, graphical modification of the data point 315 can be done by moving the stylus in one or more directions.

In this regard, a user can contact a portion of the input module 112 corresponding to the data point 315 so as to graphically modify the flat response graph 320. Specifically the data point 315 can be graphically modified to obtain a response curve 330 which is illustrated in FIG. 3d. Thus the 1 kHz frequency component can be modified by an amount proportional to the graphical modification of the data point 315. More specifically, gain which can be applied to the magnitude component corresponding to the 1 kHz frequency component can be varied by an amount proportional to the graphical modification of the data point 315.

As shown in FIG. 3d, after graphical modification, the data point 315 on the response curve 330 indicates that the gain which can be applied to the magnitude component corresponding to the 1 kHz frequency component is 3 dB. Thus extent of variation in gain which can be applied to the 1 kHz frequency component in the first exemplary scenario can be 3 dB, with 0 dB as a reference. This signifies that an approximate gain factor of numerical value “1.414” can be applied to the magnitude component corresponding to the 1 kHz frequency component. More specifically, the magnitude component corresponding to the 1 kHz frequency component can be amplified by approximately 1.414 times. Appreciably, extent of variation in gain which can be applied to the 1 kHz frequency component can correspond to an amount proportional to the graphical modification of the data point 315.

Additionally, in the above exemplary scenario, when the user moves the stylus up or down, gain applied to the magnitude components corresponding to the frequency components adjacent the 1 kHz frequency component can also be varied accordingly. In this regard, the 1 kHz frequency component can be considered to be a fundamental/primary modifiable point or a fundamental/primary frequency component. The frequency components adjacent to the 1 kHz frequency component can be considered to be auxiliary/secondary modifiable points or auxiliary/secondary frequency components.

When modifying the fundamental modifiable frequency component, extent of variation associated with the modification of the fundamental modifiable frequency component should not be less then extent of variation associated with the auxiliary modifiable frequency components. Thus, the amount of variation associated with the modification of the fundamental modifiable frequency component ought to be more than the amount of variation associated with the modification of the auxiliary modifiable frequency components.

Preferably, extent of variation for auxiliary modifiable frequency components further from the fundamental modifiable frequency component decreases. In one embodiment, decrease in extent of variation is associable with a constant reduction factor. In another embodiment, decrease in extent of variation is associable with one or both of an exponential function and a logarithmic function.

More specifically, the amount of variation associated with auxiliary modifiable frequency components nearer to the fundamental modifiable frequency component should be more compared to the amount of variation associated with auxiliary modifiable components considered to be further away from the fundamental modifiable frequency component.

Even more specifically, the amount of variation for the auxiliary modifiable frequency components can be such that amount of variation decreases as auxiliary modifiable frequency components tend away from the fundamental modifiable frequency component.

The foregoing pertaining to extent of variation will be discussed in further detail with reference to FIG. 4 and with reference to the first exemplary scenario later.

Earlier mentioned, the flat response graph 320 can be graphically modified in a manner so as to obtain a response curve 330. The response curve 330 can be associated with parameters such as the aforementioned Q factor.

Referring to FIG. 3e, in a second exemplary scenario, a user can optionally vary or adjust Q factor associated with the response curve 330.

As shown, the response graph 300 can include a first contactable point 340a and a second contactable point 340b. Furthermore, the response curve 330 can be associated with a bandwidth “Δf” relative to the fundamental modifiable frequency component (i.e., the 1 kHz frequency component). The bandwidth “Δf” can be indicative of Q factor.

A user can, for example, using two fingers to contact the first and second contactable points 340a/340b (i.e., one finger to contact a corresponding one contactable point). The user can then move the fingers toward or away from each other in a manner so as to correspondingly reduce or expand the bandwidth “Δf”. For example, via a pinching action (i.e., moving the fingers toward each other), the bandwidth “Δf” can be reduced. The opposite can be done (i.e., moving the fingers away from each other) to expand the bandwidth “Δf”. In the foregoing manner, the user can vary or adjust the Q factor as desired.

FIG. 4 shows the response curve 330 in further detail, in accordance with an embodiment of the disclosure.

The response curve 330 can be associated with a fundamental modifiable frequency component 402 and a plurality of auxiliary modifiable frequency components 404. The plurality of auxiliary modifiable frequency components 404 can include a first auxiliary modifiable frequency component 404a, a second auxiliary modifiable frequency component 404b, a third auxiliary modifiable frequency component 404c, a fourth auxiliary modifiable frequency component 404d, a fifth auxiliary modifiable frequency component 404e and a sixth auxiliary modifiable frequency component 404f.

The response curve 330 can be further associated with a fundamental extent of variation 406 and a plurality of secondary extent of variations 408. The plurality of secondary extent of variations 408 can, for example, include a first secondary extent of variation 408a, a second secondary extent of variation 408b and a third secondary extent of variation 408c. The fundamental extent of variation 406 can correspond to an amount proportional to the graphical modification of the data point 315.

The response curve 330 can yet be further associated with a reference point/level 410. The reference point/level 410 can, for example, correspond to a gain of 0 dB. More specifically, the reference point/level 410 can be indicative of a 0 dB gain level.

The fundamental modifiable frequency component 402 can, as earlier mentioned, be a 1 kHz frequency component and auxiliary modifiable frequency components can, for example, be frequency components at one or more intervals/steps relative to the fundamental modifiable frequency component 402.

For example, the auxiliary modifiable frequency components can be frequency components at one or both of increasing and decreasing 200 Hz steps with reference to the fundamental modifiable frequency component 402. In this regard, the first to sixth auxiliary modifiable frequency components 404a/404b/404c/404d/404e/404f can, for example, be 800 Hz, 1.2 kHz, 600 Hz, 1.4 kHz, 400 Hz and 1.6 kHz respectively.

Furthermore, the fundamental extent of variation 406 can correspond to the extent of variation in gain which can be applied to the magnitude component corresponding to the fundamental modifiable frequency component 402 with reference to the reference point/level 410.

The first secondary extent of variation 408a can correspond to the extent of variation in gain which can be applied to the magnitude components corresponding to the first and second auxiliary modifiable frequency components 404a/404b with reference to the reference point/level 410.

The second secondary extent of variation 408b can correspond to the extent of variation in gain which can be applied to the magnitude components corresponding to the third and fourth auxiliary modifiable frequency components 404c/404d with reference to the reference point/level 410.

The third secondary extent of variation 408c can correspond to the extent of variation in gain which can be applied to the magnitude components corresponding to the fifth and sixth auxiliary modifiable frequency components 404e/404f with reference to the reference point/level 410.

As shown, in the response curve 330, gain which can be applied to the magnitude component corresponding to the fundamental modifiable frequency component 402 is 3 dB. Thus, with respect to reference point/level 410, the fundamental extent of variation 406 can correspond to a gain of 3 dB.

Additionally, in the response curve 330, gain which can be applied to the magnitude component corresponding to each of the first and second auxiliary modifiable frequency components 404a/404b is 2.5 dB. Thus, with respect to reference point/level 410, the first secondary extent of variation 408a can correspond to a gain of 2.5 dB.

Furthermore, in the response curve 330, gain which can be applied to the magnitude component corresponding to each of the third and fourth auxiliary modifiable frequency components 404c/404d is 1 dB. Thus with respect to reference point/level 410, the second secondary extent of variation 408b can correspond to a gain of 1 dB.

Moreover, in the response curve 330, gain which can be applied to the magnitude component corresponding to each of the fifth and sixth auxiliary modifiable frequency components 404e/404f is 0.2 dB. Thus with respect to reference point/level 410, the third secondary extent of variation 408c can correspond to a gain of 0.2 dB.

Notably, gain associated with the fundamental extent of variation 406 is larger compared to the gain associated with each of the first to third secondary extent of variations 408a/408b/408c. Additionally, gain associated with the first secondary extent of variation 408a is larger compared to the gain associated with each of the second and third secondary extent of variations 408b/408c. Furthermore, gain associated with the second secondary extent of variation 408b is larger compared to the third secondary extent of variation 408c.

In this regard, it is appreciable that the gain associated with the fundamental extent of variation is the largest followed by the gain associated with the first secondary extent of variation 408a, followed by gain associated with the second secondary extent of variation 408b, followed by gain associated with the third secondary extent of variation 408c.

Furthermore, in the response curve 330, it is notable that the first and second auxiliary modifiable frequency components 404a/404b (e.g., 800 Hz and 1.2 kHz respectively) are each at a single 200 Hz step/interval from the fundamental modifiable frequency component 402 (e.g., 1 kHz). The third and fourth auxiliary modifiable frequency components 404c/404d (e.g., 600 Hz and 1.4 kHz respectively) are each at two 200 Hz steps/intervals (i.e., 400 Hz) from the fundamental modifiable frequency component 402 (e.g., 1 kHz). The fifth and sixth auxiliary modifiable frequency components 404e/404f (e.g., 400 Hz and 1.6 kHz respectively) are each at three 200 Hz steps/intervals (i.e., 600 Hz) from the fundamental modifiable frequency component 402 (e.g., 1 kHz).

Thus, it is further appreciable that the first and second auxiliary modifiable frequency components 404a/404b can be considered to be nearest to the fundamental modifiable frequency component 402 followed by the third and fourth auxiliary modifiable frequency components 404c/404d, followed by the fifth and sixth auxiliary modifiable frequency components 404e/404f.

Therefore, it is notable that the amount/extent of variation for the auxiliary modifiable frequency components 404 is such that the amount of variation decreases as auxiliary modifiable frequency components 404 tend away from the fundamental modifiable frequency component 402.

This provides a smoothening effect in that gain which can be applied to the frequency components (i.e., the plurality of auxiliary modifiable frequency components 404) adjacent the fundamental modifiable frequency component 402 can also be adjusted accordingly.

More specifically, gain can be adjusted accordingly in a manner so that gain which can be applied to magnitude components corresponding to the auxiliary modifiable frequency components 404 can be one of gradually decreased and gradually increased depending on whether the user desires gain applied to the magnitude component corresponding to the fundamental modifiable frequency component 402 to be decreased or increased.

Appreciably, such adjustment of gain can be automatic and can occur as the user adjusts gain which can be applied to the magnitude component corresponding to the fundamental modifiable frequency component 402. In this manner, gain applied to the magnitude components corresponding to the auxiliary modifiable frequency components 404 can be regulated relative to the fundamental extent of variation 406.

Advantageously, by doing so, a user need not worry about gain applied to the magnitude components corresponding to the frequency components adjacent to the fundamental modifiable frequency component 402 and gain applied to the magnitude component corresponding to the fundamental modifiable frequency component 402 being too large in difference. A large difference in gain, in the case of audio signals, may translate to a sudden raise or drop in volume (i.e., loudness) during audio perception. This may detract listening experience of the user.

Hence the aforementioned smoothening effect, by regulating gain applied to the magnitude components corresponding to the auxiliary modifiable frequency components 404, can advantageously prevent the aforementioned sudden raise or drop in volume. In this manner, a safeguard can be provided against listening experience of the user being detracted.

FIG. 5 shows a second exemplary application 500 of the system 100. The second exemplary application 500 can be in association with the aforementioned adaptive modification of the control signals.

In the second exemplary application 500, the input module 112 can further include a receiver module 502 and a processor module 504. The receiver module 502 can be coupled to the processor module 504. The receiver module 502 can, optionally, be further coupled to the input device 107. The processor module 504 can, optionally, be further coupled to the input portion 102.

The receiver module 502 can be configured to detect and receive training signals communicated from the input device 107. The processor module 504, when coupled to the input portion 102, can be configured to receive input signals communicated from the input portion 102.

Additionally, as with the first exemplary application 200, the system 100 can correspond to an electronic device in the second exemplary application 500. Similarly, the system 100 can be configured to modify audio signals and the input portion 102 can be configured to generate audio signals. In this regard, relevant portions of the foregoing discussion pertaining to the first exemplary application 200 can analogously apply to the second exemplary application 500 where appropriate.

Earlier mentioned, the input portion 102 can, for example, be configured to communicate input signals to the input device 107. The input device 107 can, for example, be configured to receive the input signals for processing to produce the training signals. Furthermore, the training signals can correspond to the aforementioned data signals.

Thus in the second exemplary application 500, the input device 107 can be configured to receive and process audio signals generated by the input portion 102. Specifically, the input device 107 can be configured to process the received audio signals based on the response characteristics of the input device 107 so as to produce the training signals. In this regard, the training signals can be indicative of the response characteristics of the input device 107. Response characteristics of the input device 107 can, for example, correspond to frequency response.

Additionally, the input device 107 can be configured to communicate training signals to the processor apparatus 104. The processor apparatus 104 can be configured to process the training signals.

Specifically, the receiver module 502 can be configured to receive the training signals. The received training signals can be communicated from the receiver module 502 to the processor module 504.

The processor module 504 can be further configured to compute/process the training signals and the received audio signals in a manner so as to derive response characteristics of the input device 107. For example, based on a comparison between the magnitude components of the received input signals and corresponding magnitude components of the training signals, applied gain, and consequently the frequency response, can be derived. Control signals can thus be modified and communicated to the processing portion 108 accordingly.

More specifically, the processor module 504 can be further configured to modify the control signals based on the derived response characteristics. The modified control signals can then be communicated from the control portion 108 to the processing portion 108.

In the foregoing manner, the control portion 110 can be configured to learn the response characteristics of the input device 107 and modify the control signals accordingly (i.e., adaptively modify the control signals).

Earlier mentioned, the processor apparatus 104 can, in another embodiment, further include an adjustment module which will be discussed in further detail hereinafter with reference to FIG. 6a and FIG. 6b.

Referring to FIG. 6a and FIG. 6b, the processor apparatus 104 can include an adjustment module 610.

In one embodiment, as shown in FIG. 6a, the adjustment module 610 can be coupled to the processing portion 108. The adjustment module 610 can be further coupled to the output portion 106. The adjustment module 610 can be configured to receive the output signals for further processing in a manner so as to produce modified output signals.

Specifically, the adjustment module 610 can be associated with generalized response characteristics. The generalized response characteristics can, for example, be associated with varying gain applied to audio signals having frequency components associable with one or more frequency ranges (e.g., bass frequencies, mid-range frequencies and treble frequencies).

In one example, the adjustment module 610 can be configured to boost the gain of bass frequencies and treble frequencies whilst applying unity gain to mid-range frequencies. In another example, the adjustment module 610 can be configured to boost the bass frequencies while applying a negative gain and unity gain to the mid-range frequencies and the treble frequencies respectively.

Thus output signals communicated to the adjustment module 610 can be varied/further processed based on generalized response characteristics to produce modified output signals. The modified output signals can be communicated to the output portion 106.

In another embodiment, as shown in FIG. 6b, the adjustment module 610 can be coupled to one or both of the processing portion 108 and the control portion 110. The adjustment module 610 can be configured to communicate adjustment signals to one or both of the processing portion 108 and the control portion 110.

Furthermore, as mentioned earlier, the adjustment module 610 can be associated with generalized response characteristics. In this regard, adjustment signals communicated from the adjustment module 610 can be indicative of the generalized response characteristics. The foregoing pertaining to the discussion of generalized response characteristics of the adjustment module 610 in FIG. 6a analogously applies.

When the adjustment module 610 is coupled to the control portion 110, the adjustment signals can be communicated from the adjustment module 610 so as to further modify the aforementioned modifiable control signals. The modifiable control signals can thus be modified based on with generalized response characteristics of the adjustment module 610.

When the adjustment module 610 is coupled to the processing portion 108, the adjustment signals can be communicated from the adjustment module 610 so as to further vary the aforementioned response characteristics associated with the processing portion 108.

Specifically, earlier mentioned, response characteristics associated with the processing portion 108 can be varied based on the aforementioned modifiable control signals communicated from the control portion 110 (i.e., one or both of graphically modifiable control signals and adaptively modifiable control signals). Appreciably, the response characteristics associated with the processing portion 108 can be further varied based on the adjustment signals.

Thus, varying response characteristics associated with the processing portion 108 based on the modifiable control signals communicated from the control portion 110 can be considered to be a first stage variance. Additionally, further varying response characteristics associated with the processing portion 108 based on the adjustment signals communicated from the adjustment module 610 can be considered to be a second stage variance.

Appreciably, response characteristics associated with the processing portion 108 can thus be effectively be varied based on one or both of a first stage variance and a second stage variance.

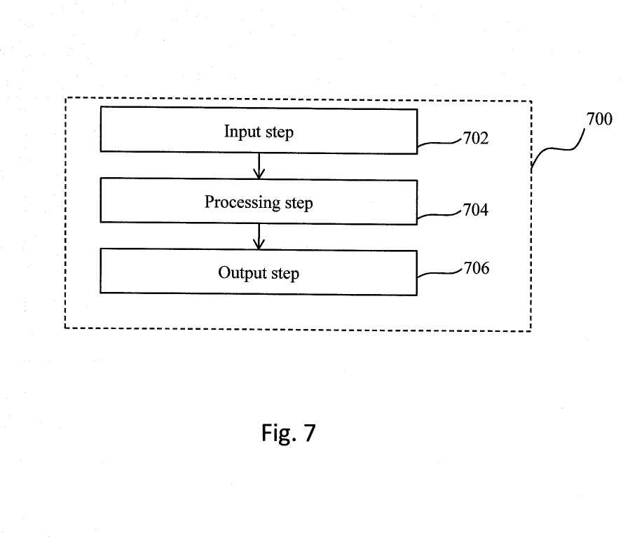

FIG. 7 shows a method 700 in association with the system 100. The method 700 can include an input step 702, a processing step 704 and an output step 706.

In the input step 702, the input portion 102 can be configured to communicate input signals to the processor apparatus 104. In the processing step 704, the processor apparatus 104 can be configured to receive and process the received input signals in a manner so as to produce output signals. In the output step 706, the output signals can be further communicated from the processor apparatus 104 to the output portion 106 for output.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

For example, earlier mentioned, the input module 112 can, for example, be a touch sensitive screen and a user can modify the response graph 300 by contacting the touch sensitive screen.

It is appreciable that the response graph 300 can be displayed using a non-touch sensitive screen and the input module 112 can correspond to, for example, a computer mouse or a trackpad module. In this regard, gesture based inputs can be applied by a user using, for example, the computer mouse or trackpad. Therefore the input module 112 can be configured to apply gesture based inputs for drawing a graphic representation.

Furthermore, although the foregoing disclosure discusses graphical modification of a data point (i.e., data point 315), it is appreciable that multiple data points (i.e., a group of fundamental modifiable points) can be graphically modified either in turn or simultaneously.

Yet furthermore, although it was earlier mentioned that, in accordance with an embodiment of the disclosure, the input device 107 can be configured to receive and process input signals communicated from the input portion 102, it is appreciable that the input device 107 can also be configured to receive input signals from another generating device/source (not shown) for processing in the manner described earlier so as to produce the training signals.

Moreover, earlier mentioned, a user can make modifications in relation to Q factor in addition to frequency response.

It is appreciable that a user can simply make modifications in relation to Q factor. Elaborating, the frequency response may be associated a plurality of peaks. A peak can, for example, be FIG. 4's data point 315 (corresponding to the fundamental modifiable frequency component 402). Appreciably, the frequency response can be associated with other peaks (not shown). Furthermore, the fundamental modifiable frequency component 402 (e.g., the 1 kHz frequency component) can be considered to be a center frequency in relation to the frequency response. In this regard, a user can make modifications in relation to Q factor of a peak (out of the plurality of peaks) in the frequency response without having to modify its center frequency (e.g., the 1 kHz frequency component).

1. An apparatus comprising:
a processor configurable for receiving input signals and processing the input signals in a manner so as to produce output signals, the processor being associable with response characteristics; and
a control portion coupled to the processor, the control portion configurable for producing control signals communicable to the processor, the control portion being configurable to receive data signals and the control signals are modifiable based on the data signals,
wherein response characteristics associable with the processor capable of being variable based on the modifiable control signals, and
wherein the processor is configurable for processing received input signals based on the variable response characteristics so as to produce the output signals.

2. The apparatus as in claim 1,
wherein the control portion comprises an input module configurable for receiving the data signals, the data signals being associable with gesture based inputs, and
wherein the gesture based inputs are applied using the input module for graphically modifying the control signals.

3. The apparatus as in claim 2,
wherein the input module is touch sensitive, and
wherein gesture based inputs are applied using the input module based on contact.

4. The apparatus as in claim 3,
wherein the gesture based inputs correspond to a graphic representation, and
wherein the graphic representation is drawn on the input module using at least one of a contact apparatus and a finger.

5. The apparatus as in claim 4,
wherein the graphical representation is associable with a plurality of data points,
wherein the input signals comprise a plurality of signal components, and
wherein the plurality of data points correspond to the plurality of signal components.

6. The apparatus as in claim 5,
wherein at least one of the plurality of data points is graphically modifiable in a manner so as to correspondingly modify signal components of a corresponding input signal, the at least one graphically modifiable data point corresponding to a fundamental modifiable point.

7. The apparatus as in claim 6, the fundamental modifiable point being modified by an amount proportional to the graphical modification of the corresponding at least one of the plurality of data points, the amount of modification of the fundamental modifiable point corresponding to fundamental extent of variation.

8. The apparatus as in claim 7,
wherein points adjacent to the fundamental modifiable point are modifiable, the points adjacent to the fundamental modifiable point being auxiliary modifiable points, the auxiliary modifiable points being associable with a plurality of secondary extent of variations, and
wherein each of the plurality of secondary extent of variations is less compared to the fundamental extent of variation.

9. The apparatus as in claim 8,
wherein the fundamental modifiable point and points adjacent to the fundamental modifiable points collectively correspond to a response curve associable with a bandwidth relative to the fundamental modifiable point,
wherein the bandwidth can be associable with Q factor, and
wherein the bandwidth is variable and Q factor is correspondingly variable.

10. The apparatus as in claim 5,
wherein more than one of the plurality of data points can be graphically modified in a manner so as to correspondingly modify signal components of corresponding input signals, the more than one graphically modifiable data point corresponding to a group of fundamental modifiable points.

11. The apparatus as in claim 1, the control portion comprising an input module configurable for applying gesture based inputs for drawing a graphic representation so as to graphically modify the control signals communicable to the processor.

12. The apparatus as in claim 1 being configurable to communicate with an input device which is associable with response characteristics, the input device being configurable to produce training signals corresponding to the data signals, the training signals being indicative of the response characteristics of the input device.

13. The apparatus as in claim 1 further comprising an adjustment module coupled to the processor, the adjustment module being associable with generalized response characteristics.

14. The apparatus as in claim 13 wherein the adjustment module is configurable to receive the output signals for processing based on the generalized response characteristics so as to produce modified output signals.

15. The apparatus as in claim 13,
wherein the adjustment module is configurable for communicating adjustment signals indicative of the generalized response characteristics to at least one of the processor and the control portion,
wherein when the adjustment module is coupled to the control portion, the adjustment signals are communicated from the adjustment module so as to further modify the modifiable control signals, and
wherein when the adjustment module is coupled to the processor portion, response characteristics associated with the processing portion are effectively varied based on at least one of a first stage variance associable with the modifiable control signals and a second stage variance associable with the adjustment signals.
